(19) United States
(12) Patent Application Publication
(10) Pub. No.: US 2017/0328554 A1
(43) Pub. Date: Nov. 16, 2017

(54) LED LIGHT SOURCE APPARATUS

(71) Applicant: HABEMIT INTERNATIONAL CO. LTD., Taoyuan City (TW)

(72) Inventors: Chin-Wen WANG, Taoyuan City (TW); Tzu WANG, Taoyuan City (TW)

(21) Appl. No.: 15/201,551

(22) Filed: Jul. 4, 2016

(30) Foreign Application Priority Data
May 10, 2016 (TW) 105114478

(51) Int. Cl. F21V 31/00; F21V 19/00; F21S 8/08; F21V 23/00; F21V 29/76; F21V 5/04; F21V 8/00; F21V 23/06; F21W 131/103; F21Y 2115/10

(52) U.S. Cl. CPC F21V 31/005; G02B 6/0001; F21V 19/003; F21S 8/086; F21V 23/06; F21V 23/001; F21V 29/76; F21V 5/04; F21Y 2115/10; F21W 2131/103

(57) ABSTRACT

An LED light source apparatus includes a lamp housing, a lighting module, and a lens. The lamp housing has a first shell body, a second shell body, and a waterproof pad disposed between the first and second shell bodies. The first shell body and the second shell body are covered to each other. The second shell body has an opening. The waterproof pad is provided with a throughhole corresponding to the opening. A light guide flap is disposed on the perimeter of the opening of the second shell body. The lighting module is disposed inside the lamp housing corresponding to the opening. The lens is installed on a side of the lamp housing corresponding to the lighting module. Therefore, the components or the lighting module with a different power can be conveniently replaced by modules and thus the present invention has the flexibility in replacement and maintenance.

### BACKGROUND OF THE INVENTION

### Field of the Invention

The present invention relates to a light source apparatus and in particular to an LED light source apparatus which has the flexibility in replacement and maintenance and has uniform illuminations.

### Description of Prior Art

Because the LED (light-emitting diode) has the advantages of energy-saving lighting, power saving, long lifespan, and high brightness, it has been widely used in different fields of illumination, especially in the field of outdoor illumination.

When an existing LED outdoor lamp has a water leak or is damaged due to some reasons, the maintenance worker usually needs to replace the whole light source apparatus, which causes a high maintenance cost and insufficient flexibility in replacement. Besides, the existing lighting apparatus has directivity with a specific angle and the feature of light concentration. As a result, the illumination will be limited within a relatively small region and the brightness will decrease with the increasing illumination range, which cannot meet the requirements of uniform illumination of general lighting.

In view of this, the inventor pays special attention to research with the application of related theory and tries to improve and overcome the above disadvantages regarding the above related art, which becomes the improvement target of the inventor.

### SUMMARY OF THE INVENTION

One objective of the present invention is to provide an LED light source apparatus which allows convenient replacement of components or lighting modules with different powers by modules and has flexibility in replacement and maintenance.

Another objective of the present invention is to provide an LED light source apparatus which can provide uniform illumination.

To achieve the above objectives, the present invention provides an LED light source apparatus which comprises a lamp housing, a lighting module, and a lens. The lamp housing has a first shell body, a second shell body, and a waterproof pad disposed between the first shell body and the second shell body, wherein the first shell body and the second shell body are coved to each other. The second shell body has an opening; the waterproof pad is provided with a throughhole corresponding to the opening; a light guide flap is disposed on the perimeter of the opening of the second shell body. The lighting module is disposed inside the lamp housing corresponding to the opening. The lens is installed on a side of the lamp housing corresponding to the lighting module.

The present invention also has the following advantages. The effects of convenient replacement or maintenance can be quickly achieved by modular design. That is, the external sizes of the lamp housing, the first shell body, and the second shell body are consistent while the internal sizes of the second shell body and the waterproof pad change according to the size of the lighting module with a different power. The maintenance worker can replace the whole LED light source apparatus or the internal components thereof; thus the present invention has the flexibility in replacement and maintenance.

Besides, a single or plural light guide flaps disposed on the perimeter of the opening of the second shell body can uniformly reflect/refract the lights from the lighting module to expand the illumination range and increase the illumination efficiency of the light source. By means of the waterproof ring sleeved around the flange of the lens, the moisture is not easy to seep through the gap between the lens and the frame to enhance the waterproof effect.

### BRIEF DESCRIPTION OF DRAWING

FIG. 1 shows an exploded schematic view of the LED light source apparatus according to the first preferable embodiment of the present invention;

FIG. 2 shows an exploded schematic view of the LED light source apparatus according to the first preferable embodiment of the present invention from another view;

FIG. 3 shows a perspective assembled view of the LED light source apparatus according to the first preferable embodiment of the present invention, which shows the vapor chamber installed on the waterproof pad;

FIG. 4 shows a perspective assembled view of the LED light source apparatus according to the first preferable embodiment of the present invention from another view, which shows the vapor chamber installed on the waterproof pad);

FIG. 5 shows a perspective view of the lighting module of the present invention illuminating uniform light through the light guide flaps;

FIG. 6 shows a top view of the LED light source apparatus according to the first preferable embodiment of the present invention;

FIG. 7 shows a cross-sectional view of the LED light source apparatus according to the first preferable embodiment of the present invention in operation;

FIG. 8 shows a top view of the LED light source apparatus according to the second preferable embodiment of the present invention;

FIG. 9 shows a cross-sectional view of the LED light source apparatus according to the second preferable embodiment of the present invention in operation;

FIG. 10 shows a perspective view of the LED light source apparatus of the present invention installed on an outdoor lamp; and

FIG. 11 is a cross-sectional view of FIG. 10.

### DETAILED DESCRIPTION OF THE INVENTION

The detailed description and technical details of the present invention will be explained below with reference to accompanying drawings. However, the accompanying drawings are only for reference and explanation, but not to limit the scope of the present invention.

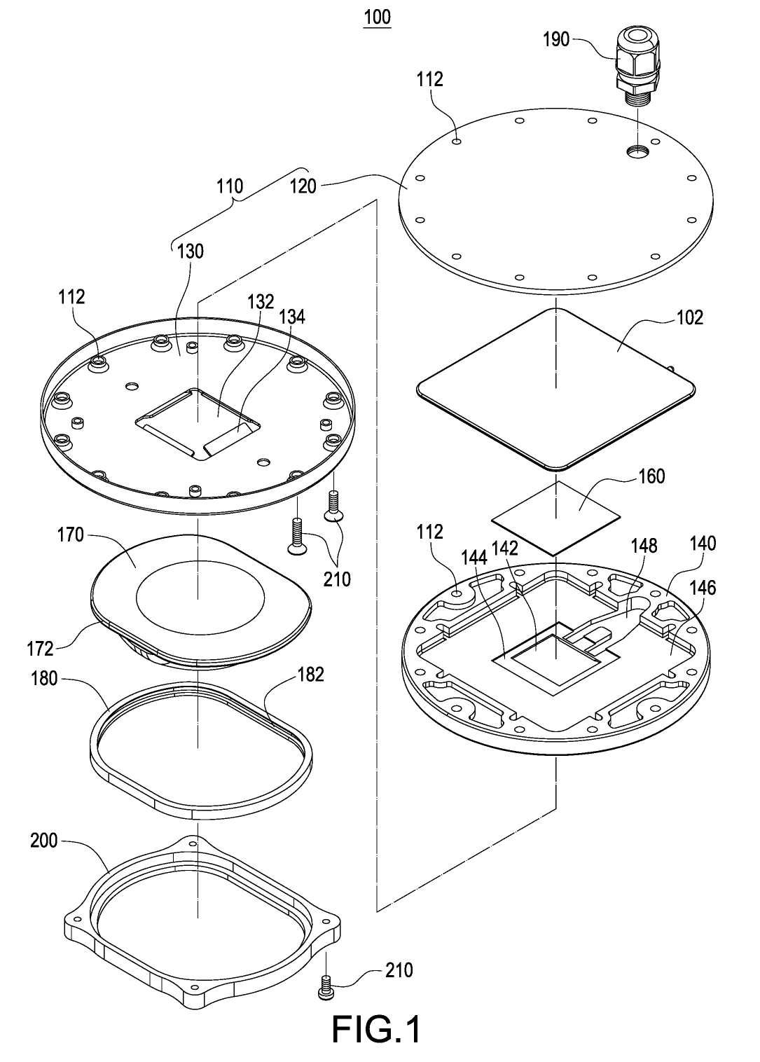

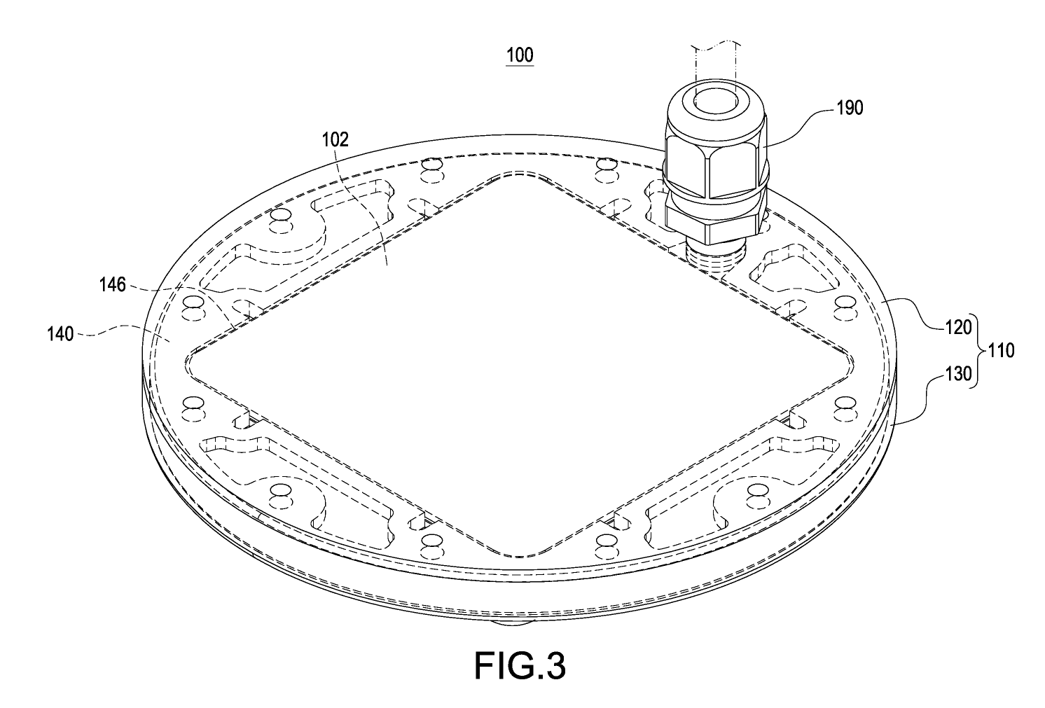

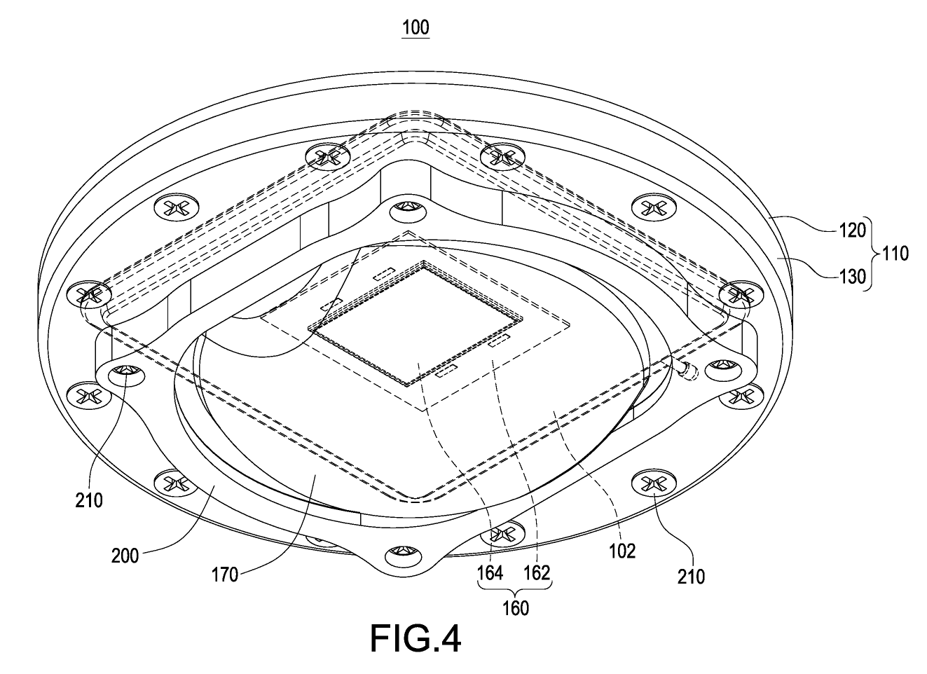

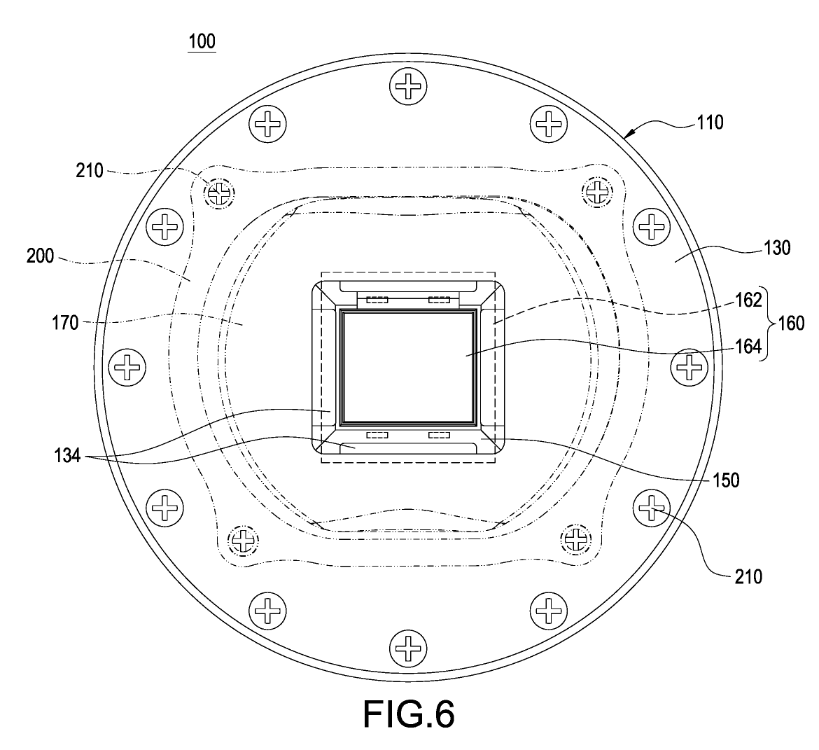

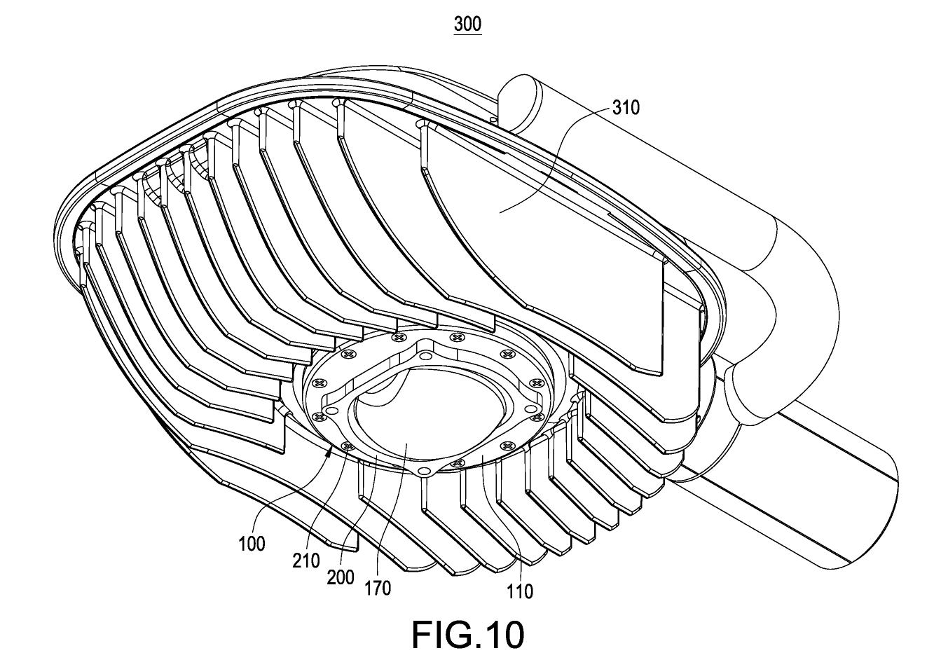

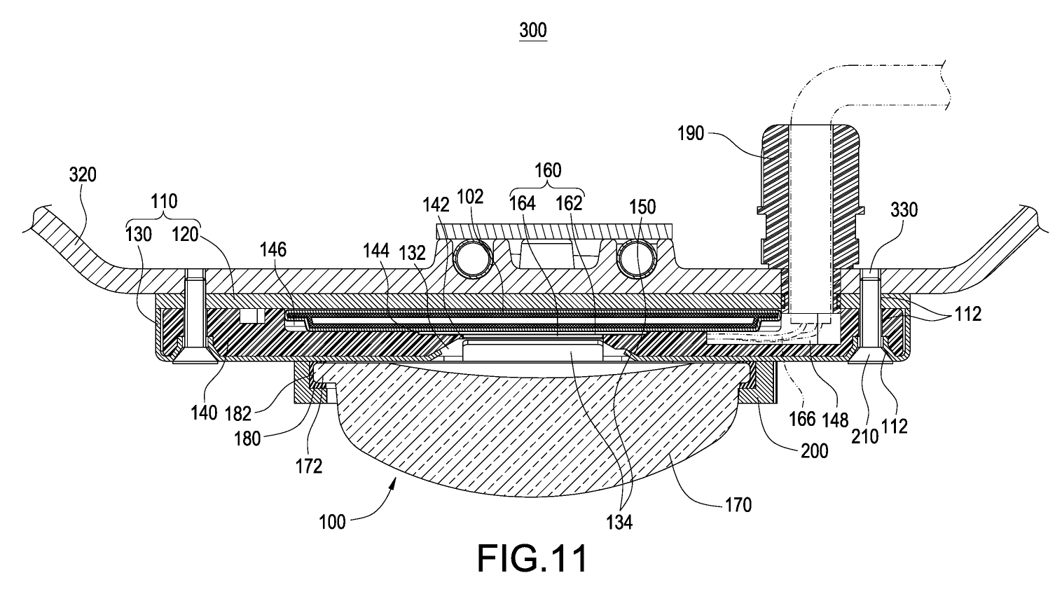

As shown in FIGS. 1-7, they show the related views of the LED light source apparatus according to the first preferable embodiment of the present invention. The present invention provides an LED light source apparatus 100 comprising a lamp housing 110, a lighting module 160, and a lens 170. The LED light source apparatus 100 here is preferably used in an outdoor illuminating lamp, e.g., a road lamp, as shown in FIGS. 10 and 11. However, in other embodiments, the LED light source apparatus 100 can be used in the places such as a factory, a gym, a park, or other proper places.

The lamp housing 110 has a first shell body 120, a second shell body 130, and a waterproof pad 140 disposed between the first shell body 120 and the second shell body 130, wherein the first shell body 120 and the second shell body 130 are coved to each other. In the current embodiment, the first shell body 120 and the second shell body 130 are preferably made of metal or the alloy; the waterproof pad 140 is made of plastic, rubber, or other electrically insulated materials. Also, in the current embodiment, the lamp housing 110 preferably has a circular contour; however, the lamp housing 110 may have a rectangular shape or other proper shapes in other embodiments.

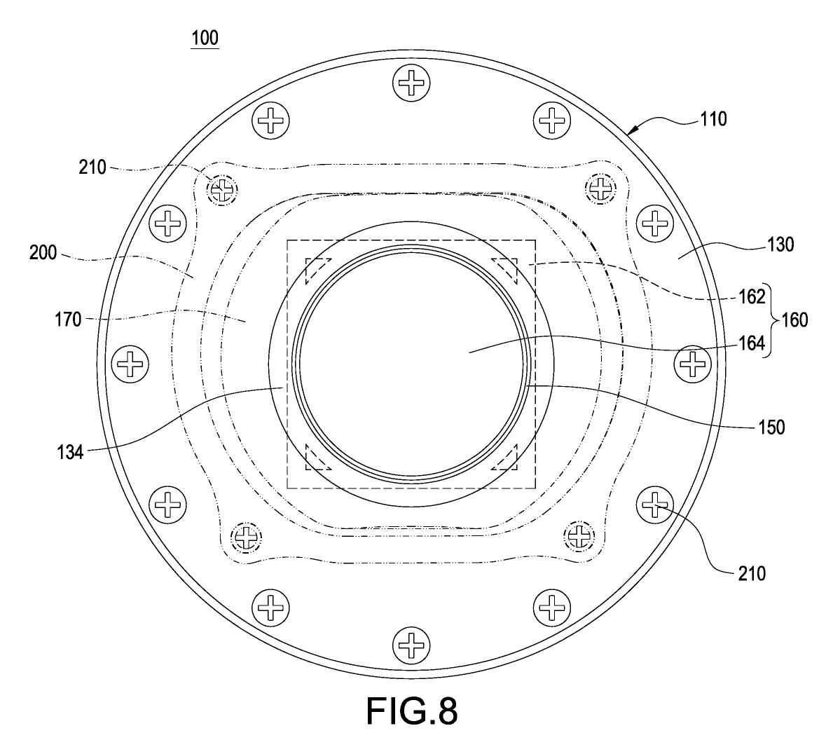

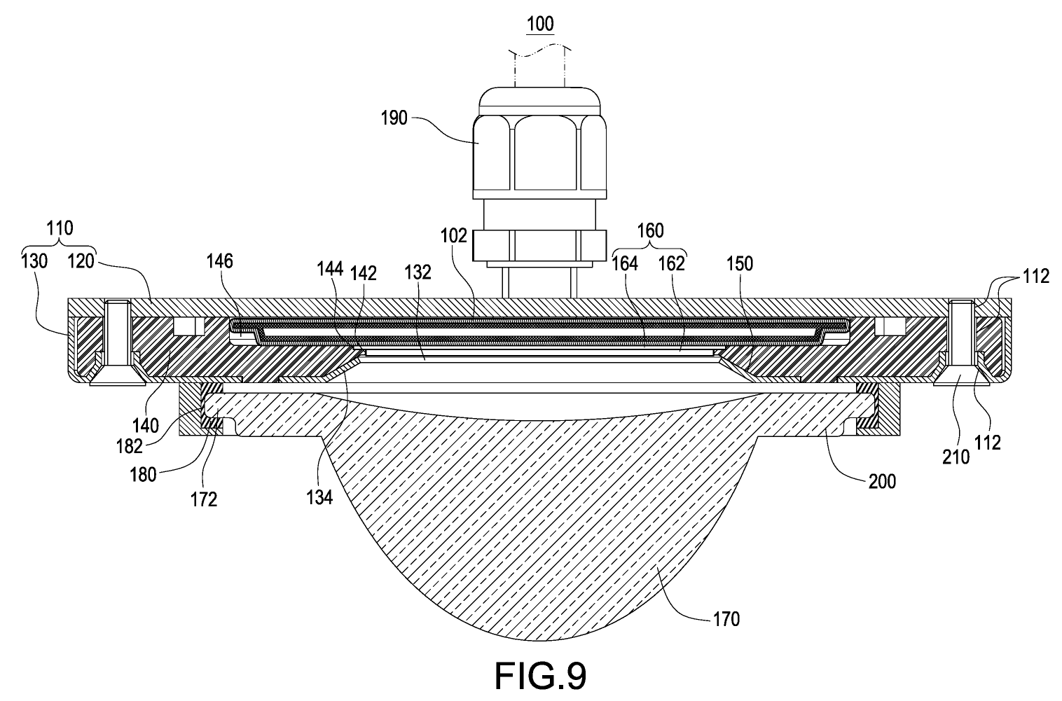

The second shell body 130 has an opening 132 and the waterproof pad 140 is provided with a throughhole 142 corresponding to the opening 132 in which a light guide flap 134 is disposed on the perimeter of the opening 132 of the second shell body 130. In the embodiment shown in FIGS. 1, 2, and 5, the opening 132 and the throughhole 142 are preferably rectangular holes and the second shell body 130 comprises four light guide flaps 134 disposed on the perimeter of the rectangular hole. However, in the second preferable embodiment shown in FIGS. 8 and 9, the opening 132 and the throughhole 142 can be circular holes and the light guide flap 134 is shaped like a continuous ring. The number, sizes, and angles of the light guide flaps 134 change according to various lighting modules 160 with different powers, which are not limited in the present invention.

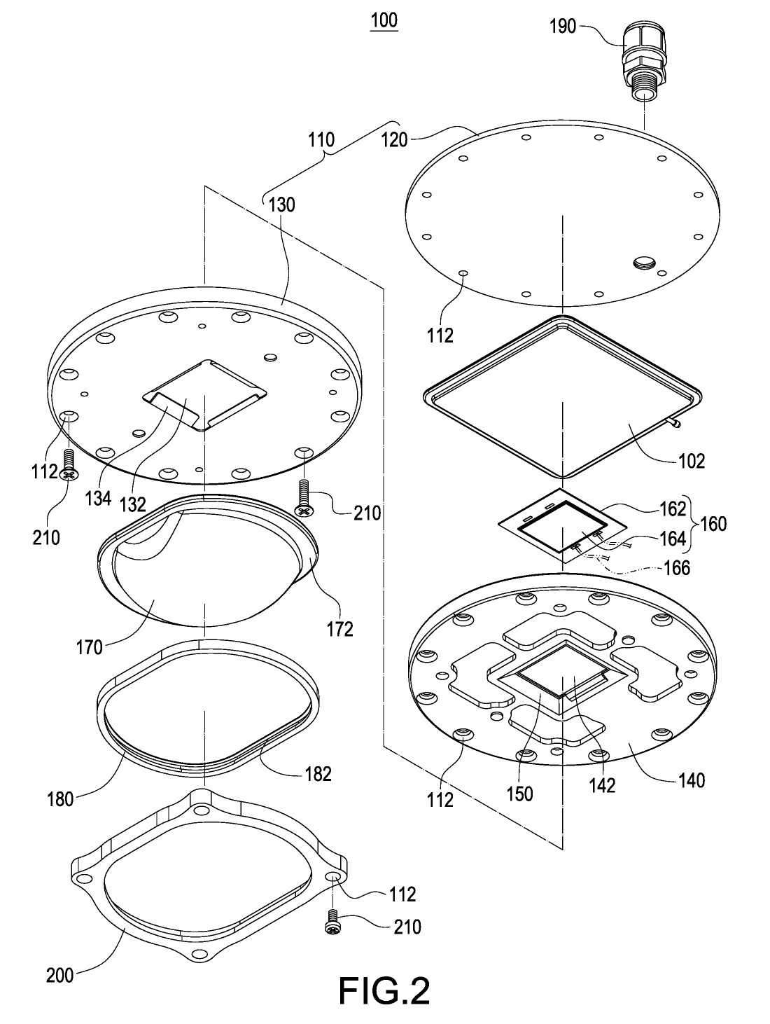

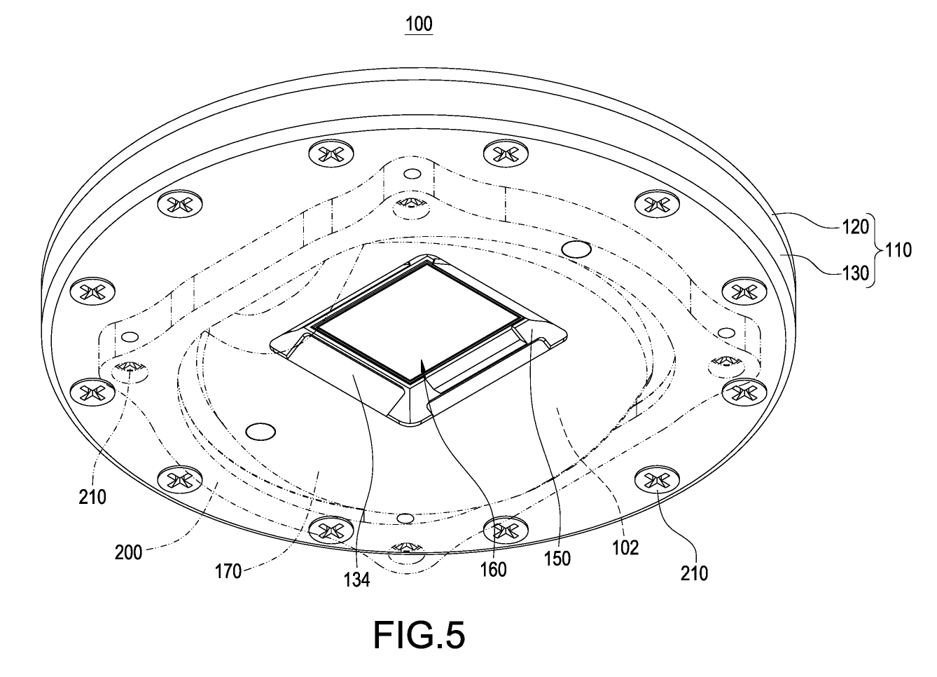

The lighting module 160 is disposed inside the lamp housing 110 corresponding to the opening 132. In the embodiment shown in FIGS. 1, 3, and 7, the waterproof pad 140 has a first receiving recess 144 and a second receiving recess 146 disposed on one side thereof. The lighting module 160 can be received in the first receiving recess 144. An inclined surface 150 is formed on the other side, facing the light guide flap 134, of the waterproof pad 140 such that the light guide flap 134 is attached on the inclined surface 150, as shown in FIGS. 2, 5, and 6. In the embodiment shown in FIGS. 5, 6, and 7, each of the light guide flaps 134 of the second shell body 130 is bent toward the throughhole 142 and attached on the inclined surface 150 such that the lighting module 160 forms a cup surface of reflection (not shown) around the opening 132. By means of at least one light guide flap 134, the lights from the lighting module 160 can be uniformly reflected/refracted and thus the illumination range is expanded and the illumination efficiency of the light source is increased.

In the first preferable embodiment, the present invention further comprises a vapor chamber 102 received in the second receiving recess 146. A side surface of the lighting module 160 is attached on a surface of the vapor chamber 102; another surface of the vapor chamber 102 is pressed against an inner side of the first shell body 120. The vapor chamber 102 here is a flat shell body made of metal preferably with high thermal conductivity such as copper or aluminum and allows a working fluid and wick structures to be disposed inside to improve the efficiency of heat dissipation. Therefore, the vapor chamber 102 can absorb the heat from the lighting module 160 during operation and dissipate the waste heat through itself. Then, the heat is dissipated out of the lamp housing 110 by the first shell body 120.

In the embodiment in FIGS. 1, 2, and 7, the present invention further comprises a wire connector 190 disposed on the first shell body 120, and the waterproof pad 140 has a wiring recess 148 communicating with the first shell body 144. The lighting module 160 comprises a PCB (printed circuit board) 162, at least one LED 164 attached on the PCB 162, and a plurality of wires 166 connected to the PCB 162. The wires 166 are laid along the lamp housing 110 and penetrate out of the wire connector 160.

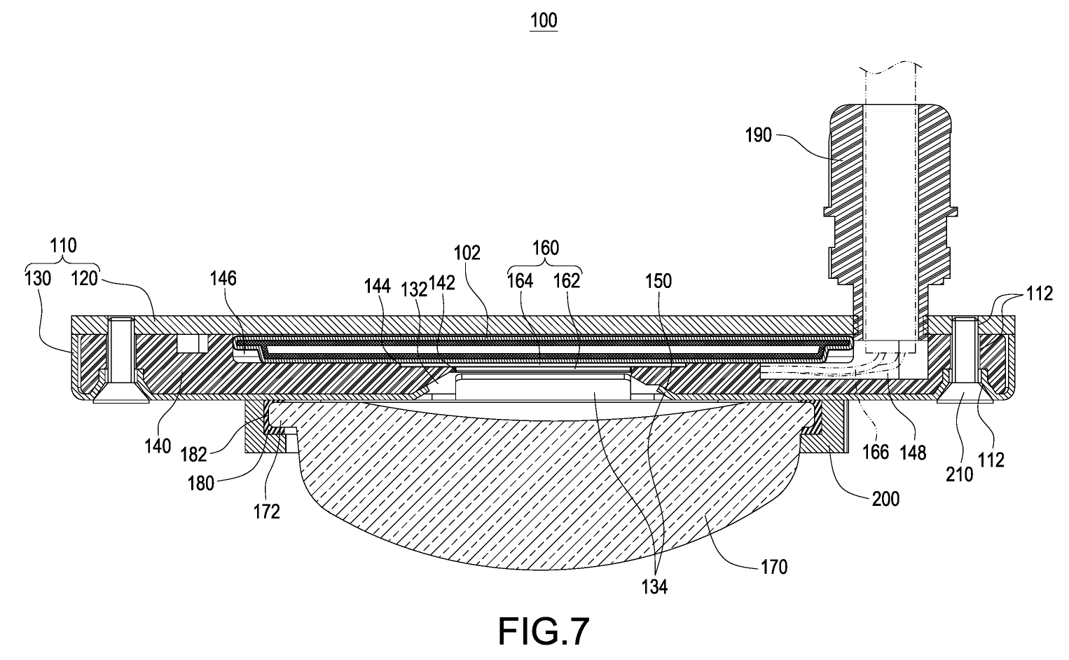

The LED 164 of the lighting module 160 is a point light source having an extremely concentrated illumination and thus it is necessary to install the lens 170 to adjust the illumination shape. As shown in FIGS. 2, 4, and 7, the lens 170 is preferably installed on a side of the lamp housing 110 corresponding to the lighting module 160. Moreover, to enhance the waterproof effect, the first preferable embodiment of the present invention further comprises a waterproof ring 180 surrounding on the perimeter of the lens 170 and a frame 200 positioning the waterproof ring 180 and the lens 170 to the second shell body 130. In the embodiment shown in FIGS. 1 and 7, the lens 170 has a flange 172; the waterproof ring 180 preferably has a groove 182 sleeved around the flange 172 of the lens 170. In this way, the moisture is not easy to seep through the gap between the lens 172 and the frame 200 to enhance the waterproof effect.

In the first preferable embodiment, the present invention further comprises a plurality of fasteners 210 such as screws or bolts. The lamp housing 110 has a plurality of assembly holes 112. The fasteners 210 individually pass through the corresponding assembly holes 112 to screw the lamp housing 110. That is, the first shell body 120, the second shell body 130, and the waterproof pad 140 are all provided with the assembly holes 112 at the corresponding positions, which facilitates the firm screwing of the assembly holes 112 and the fixing of the above components to the lamp housing 110.

When the maintenance worker wants to replace the lighting module 160 with a new one having a different power, he has to remove the associated fasteners 210 in sequence and uninstall the second shell body 130 and the waterproof pad 140. Then, he can replace the lighting module 160. Generally speaking, the lighting module 160 has higher power and increases in size, the sizes of the throughhole 142 of the lighting module 160 and the opening 132 of the second shell body 130 also increase in size accordingly. Therefore, the waterproof pad 140 used to install the lighting module 160 and the second shell body 130 corresponding to the waterproof pad 140 needs to be replaced together to fit.

Thus, the LED light source apparatus 100 in the current embodiment has a modular design, which can quickly achieve the effects of convenient replacement and maintenance. That is, the external sizes of the lamp housing 110, the first shell body 120, the second shell body 130, and the waterproof pas 140 are consistent while the internal sizes of the second shell body 130 and the waterproof pad 140 change according to the size of the lighting module 160 with a different power. Depending on the demand, the maintenance worker can replace the whole LED light source apparatus 100 or only replace the internal components thereof; thus the LED light source apparatus 100 of the present invention allows convenient replacement of components or lighting modules with different powers by modules and has the flexibility in replacement and maintenance.

Please refer to FIGS. 8 and 9, which show the top view and the cross-sectional view of the LED light source apparatus according to the second preferable embodiment of the present invention, respectively. The difference between the current embodiment and the previous embodiment is that the lighting module 160 has a different power and thus the corresponding opening 132 and the throughhole 142 corresponding to the LED 164 differ in shapes. In the current embodiment, the LED 164 of the lighting module 160 is circular and thus the throughhole 142 of the waterproof pad 140 and the second shell body 130 are also circular. In addition, the light guide flap 134 is preferably shaped like a continuous ring and attached on the inclined surface 150 to uniformly reflect the lights from the lighting module 160 to expand the illumination range and increase the illumination efficiency of the light source.

As shown in FIGS. 10 and 11, they show the perspective view of the LED light source apparatus of the present invention installed on an outdoor lamp and the cross-sectional view of FIG. 10, respectively. The above-mentioned lamp here is preferably the road lamp 300, but not limited to this. The road lamp 300 comprises a plurality of fins 310, a base 320 connected to the fins 310, and a plurality of assembly holes 330 disposed on the base 320.

The assembly holes 330 of the road lamp 300 are individually and preferably disposed corresponding to some of the assembly holes 112 of the lamp housing 110. Then, some of the fasteners 210 can pass through the assembly holes 112 of the lamp housing 110 and be firmly screwed to the base 320. In this way, the LED light source apparatus 100 is fixed to the base 320 of the road lamp 300. Also, the first shell body 120 of the lamp housing 110 is attached on the bottom surface of the base 320. Therefore, the vapor chamber 102 absorbs the waste heat from the lighting module 160 and diffuses the waste heat to each of the fins 330 through the first shell body 120. As a result, the effect of fast heat dissipation can be achieved.

When the maintenance worker wants to replace the lighting module 160 with a new one having a different power, he removes the fasteners 210 and then he can uninstall the lighting module 160. The maintenance worker can perform necessary replacement or maintenance of the internal components of the lighting module 160 of the LED light source apparatus 100. The detailed replacement procedure can be referred to in the previous description and not be repeated here.

In summary, the embodiments disclosed in the description are used to explain the present invention, but not to limit the scope of the present invention. The scope of the present invention should be embraced by the accompanying claims and includes all the equivalent modifications and not be limited to the previous description.

What is claimed is:

1. An LED (light emitting diode) light source apparatus, comprising:
a lamp housing having a first shell body, a second shell body, and a waterproof pad disposed between the first shell body and the second shell body, wherein the first shell body and the second shell body are coved to each other, the second shell body has an opening, the waterproof pad is provided with a throughhole corresponding to the opening, and a light guide flap is disposed on the perimeter of the opening of the second shell body;
a lighting module disposed inside the lamp housing corresponding to the opening; and
a lens installed on a side of the lamp housing corresponding to the lighting module.

2. The LED light source apparatus according to claim 1, wherein the waterproof pad has a first receiving recess and a second receiving recess disposed on one side thereof, and the lighting module is received in the first receiving recess.

3. The LED light source apparatus according to claim 2, wherein an inclined surface is formed on the other side, facing the light guide flap, of the waterproof pad, and the light guide flap is attached on the inclined surface.

4. The LED light source apparatus according to claim 2, further comprising a vapor chamber received in the second receiving recess, wherein a side surface of the lighting module is attached on a surface of the vapor chamber, and another surface of the vapor chamber is pressed against an inner side of the first shell body.

5. The LED light source apparatus according to claim 2, wherein the waterproof pad further comprises a wiring recess communicating with the first shell body.

6. The LED light source apparatus according to claim 1, wherein the opening and the throughhole are rectangular holes, and the second shell body further comprises four light guide flaps bent and disposed on the perimeter of the rectangular hole.

7. The LED light source apparatus according to claim 1, wherein the opening and the throughhole are circular holes, and the light guide flap is shaped like a continuous ring.

8. The LED light source apparatus according to claim 1, further comprising a wire connector disposed on the first shell body, wherein the lighting module further comprises a PCB (printed circuit board), at least one LED attached on the PCB, and a plurality of wires connected to the PCB.

9. The LED light source apparatus according to claim 8, wherein the wires are laid along the lamp housing and penetrate out of the wire connector.

10. The LED light source apparatus according to claim 1, further comprising a waterproof ring surrounding on the perimeter of the lens and a frame positioning the waterproof ring and the lens to the second shell body.

11. The LED light source apparatus according to claim 10, wherein the lens has a flange, and the waterproof ring has a groove sleeved around the flange.

12. The LED light source apparatus according to claim 1, further comprising a plurality of fasteners, wherein the lamp housing comprises a plurality of assembly holes, and the fasteners individually pass through the corresponding assembly holes to screw the lamp housing.
